(19) United States
(12) Patent Application Publication
(10) Pub. No.: US 2014/0311888 A1
(43) Pub. Date: Oct. 23, 2014

(54) PROCESS FOR THE PREPARATION OF AQUEOUS SOLUTIONS

(71) Applicant: Fariba Khandanian, Bispingen (DE)

(72) Inventor: Fariba Khandanian, Bispingen (DE)

(21) Appl. No.: 14/358,654

(22) PCT Filed: Nov. 16, 2012
(86) PCT No.: PCT/EP2012/072916

§ 371 Date: May 15, 2014

(30) Foreign Application Priority Data
Nov. 18, 2011 (DE) 102011055514.5

(51) Int. Cl. B01D 3/00

(52) U.S. Cl. CPC B01D 3/007
USPC 203/24; 202/180

(57) ABSTRACT

The invention relates to a vapor-compression method. The aim of the invention is to provide such a method respectively a system with which a distillation with a further reduced energy requirement is possible, which simultaneously operates reliably, with little maintenance, and with only little available power, in particular when starting, and which is able to handle fluctuations in the available power. This is achieved in that an aqueous solution is preheated and fed to an evaporator at a lower end in order to generate vapor. The vapor is conducted from an upper end of the evaporator to a compressor (V) in order to be compressed. The vapor that is compressed in the compressor (V) is used to supply energy to the evaporator. The vapor that is thus cooled or optionally at least partly condensed is used to preheat the aqueous solution. Furthermore, the method according to the invention is characterized in that the preheated aqueous solution in the evaporator is heated in evaporator tubes around which the compressed vapor is flushed, and at least one heater that is arranged diagonally in particular is provided in or upstream of the evaporator.

The present invention relates to a vapor compression method and a corresponding vapor compression system.

Such methods and systems are known in large numbers from the prior art. For example, from DE 103 25 230 A 1 a corresponding method or an appropriate system is known.

Although the vapor compression method draw basically already a comparatively low energy consumption, but it is the task of the present application to provide a method and a system with which a distillation with further reduced energy consumption is possible, both very reliable and maintenance as possible and in particular also available with only small performance, especially when starting, and manages to deal in terms of performance variations in the available power can be.

This object is achieved by a method according to claim 1 and a system according to claim 4 the dependent claims 2-3 and 4-10 indicate advantageous developments.

According to the invention the process for the preparation of aqueous solutions can be used in various application scenarios. For example, it produces drinking water or can purify waste water. It is also possible to concentrate (harmful and/or value) substances, contained in aqueous solutions, by the method.

According to the invention an aqueous solution is preheated and fed to the preheated aqueous solution of a lower end of an evaporator to generate steam. The steam is supplied from an upper end of the evaporator, in particular directly, in particular without additional heating of further enrichment by vapor filtering and/or deposition, a compressor for compressing. The vapor is compressed in the compressor, used in particular, directly, without additional heating and in particular, separation, filtration and/or concentration by further supply of energy to the vapor in the evaporator. The resulting cooled, optionally at least partially condensed vapor is used to preheat the aqueous solution. The inventive method is further characterized in that the preheated aqueous solution is heated in the evaporator in the evaporator tubes, lapped from the compressed vapor and at least one, especially arranged obliquely, additional heating in or before the evaporator is provided.

The auxiliary heating is inventively arranged precisely so that the rising by heating raw water enters the obliquely arranged straight tubes of the evaporator in the way that a natural circulation, which for a self-regulating system's response to fluctuations that in small systems due to the low capacity cause problems, and support the difficult especially for small plants start is possible.

The radiators are for this purpose according to the invention preferably designed so that the heat release (heating spot, HS) occurs at a defined location.

By using of the compressed vapor both for heating the evaporator and for preheating a particularly good energy yield is achieved.

This is ensured particularly by the direct use of the compressed vapor to the flowing around the evaporator tubes.

The additional heating arranged in or in front of the evaporator provides a control of operation and an effect of starting the process.

Alternatively or additionally, a control by adjusting the speed of the below according to the invention is possible.

Particularly advantageous at least one return pipe is provided with respect to the evaporator tubes of larger cross-section.

The larger cross-section of the return pipe refers to a comparison with one of the evaporator tubes, and/or for comparison with the sum of the cross sections of the evaporator tubes.

Such a return pipe is arranged such that non-vaporized aqueous solution can fall into the lower part of the evaporator and due to the flow through the density gradient ascends in the evaporator tubes and can be reheated there.

Advantageously, the aqueous solution is heated in ramped evaporator tubes, wherein the evaporator tubes are inclined in the direction of the return pipe towards the top.

With the provision of a single downcomer, the evaporator tubes are advantageously at least partially inclined in the direction of said return tube.

This means that the upper end thereof in the cross-section is arranged closer to the upper end of the return tube, as the bottom end of the evaporator tube.

Is an exterior and extending to the evaporator tubes return pipe is provided, for example, the evaporator tubes are inclined towards the outside.

With a circular return pipe the correspondingly inclined evaporator tubes thus end up at a larger radius, as they start at the bottom.

The inclination of the evaporator tubes is dependent on the capacity of the facility and is advantageously not more than 40° as measured from the vertical. In particular the inclination is in the interval 10° to 40°.

Such pipes or evaporator by a corresponding arrangement and heating a particularly advantageous trained natural circulation can be generated, in particular, forms a laminar flow, and so leads to reduced deposits in the evaporator tubes.

This arrangement of pipes according to the invention advantageously leads to a flow of rising due to the heating and the resulting raw water density which supports natural circulation, allowing the process to respond to a self-regulating fluctuations. On the outer side of the pipes according to the invention obliquely arranged condensed steam in a manner which is known to the prior art both vertically and horizontally arranged pipes especially favorable. Generally, steam is condensed on a surface when the wall temperature is below the saturation temperature of the vapor. The condensate is then deposited on the wall as a continuous liquid film (film condensation) or in droplets (droplet condensation). In the steam condensation, the wet ability of the cooling surface and the surface tension of the condensate play a crucial role. The condensate wets the vertical cooling surface, the result is a coherent, insulating liquid film (film condensation), which degrades the heat transfer. This flow down to the wall becomes thicker and forms an increasing heat transfer resistance 1/α. In the construction of the inclined tubes, the steam is first guided to the pipe surface, which is located at the inclined pipe above, thereby forming a thinner film which holds a lower surface resistance and the heat transfer better. On the tube surface, which is inclined downwards, the film tapering with a greater thickness due to the gravitational force and thus covers a smaller area, whereby said surface of turns smaller with a higher heat resistance, and overall heat transfer session is effective.

Advantageously, the heating or warming the aqueous solution is carried out in straight evaporator tubes. The evaporator tubes are thus advantageously not bent and particularly have a constant length of your cross section. This allows an easy cleaning, especially if the evaporator tubes are easily accessible by a removable evaporator head. For the purification according to the invention, the compressor head, which is connected via exactly one flange with the apparatus, accurately so decreased that the raw water does not have to be discharged and can remain in the evaporator. Thus, the obliquely arranged straight evaporator tubes are freely accessible from above and can be easily cleaned with a simple round brush for example. This arrangement, according to the invention, also provides that the pipes during cleaning do not dry traps and the drying of that dirt, which then form the germ for fouling, during operation does not arise. In addition, according to the present invention, the heat of the raw water, which is located in the evaporator, will not lose, so that the plant after cleaning can quickly be restarted. All this is with horizontally arranged tubes in accordance to the prior art not possible. The dirt particles, which are released during cleaning, may fall within the scope of the invention through the straight pipes on the bottom of the unit, where they can be flushed out by the generously dimensioned brine and drain away from the process. With horizontally disposed tubes in the prior art, the impurities follow the gravity and remain in the tubes and may be adhered there by drying and nuclei for the undesirable encrustation, making a total cleaning of conventional systems is inefficient.

With particular advantage, a central tube bundle evaporator is provided, and the return pipe outside of the evaporator tube bundle, arranged in particular such that it surrounds the evaporator tube bundle. The return pipe encloses the evaporator tubes, to utilize the heat losses occurring in the process. The raw water, which is located outside near the surface is slightly cooler than the raw water in the center of the plant. It has been observed that the arrangement according to the invention support the natural circulation. The principle of natural circulation is thus present invention provides a self-regulating system.

The cooling of the evaporator tubes, according to the invention, is carried by the circulating raw water quantities that adjust automatically depending on the heating. A stronger heating of the evaporator tubes, which can be achieved, according to the invention, for example with higher rotational speeds of the below results in greater natural circulation speeds. Due to the higher Flow velocities the evaporator tubes, according to the invention, are then cooled better with advantage, so that the risk of overheating of the evaporator tubes is reduced, this is a great advantage of the natural circulation of the invention. As a result, the capacitance increases and more waste water are purified.

In order to respond to fluctuations in the condensate, can be used in the invention, the amount of raw water, which is heated by the preheater by just this condensate may be adapted to the amount of condensate, so that the amount of raw water varies with time simultaneously with the condensate in order to enable an effective preheating.

In the method according to the invention and evaporator turns to advantage the process so that a crust does not occur.

In a preferred embodiment, a natural circulation is assisted by a density gradient in the evaporator tubes, an inclination of the evaporator tubes, an outboard return pipe and the orientation and construction of the heating elements in the inventive system and the inventive method. This leads to a significant advantage with stable and self-regulating behavior of the system as in conventional systems.

Here, the compressed vapor is advantageously centrally, in particular by at least one centrally arranged, in particular conical, impact component, in particular made from above in the middle of the evaporator tube bundle. Such guide gives a particularly efficient distribution and utilization of the steam. The arrangement of the baffle in the height and the angle of the cone are, according to the invention, chosen depending on the flow velocity of the steam and the number of evaporator tubes, which are selected, in accordance with the invention, in turn a function of the surface of the evaporator. The lower the angle of the cone baffle is designed, the higher it is arranged, according to the invention, thereby evenly as possible flushing of the evaporator tubes sought by steam.

The impact compositions of the invention can be dimensioned during the design. In an advantageous embodiment of the invention, the positioning of the baffle means may also be varied during operation to optimize. This adjustment means are provided according to the invention. Particularly advantageously, the aqueous solution is preheated after passing through the preheater so that it has a temperature of 80° C. to 98° C., especially from 93° C. to 96° C. This can be done through an appropriate design of the heat exchanger. In a process control such a particularly efficient process design is possible.

Particularly advantageously, the pressure at the top of the evaporator is set by controlling the auxiliary heating and/or the compressor, in particular the rotational speed of the compressor, to 0.9 to 1.5 bar, and in particular 1.05 bar. This also results in a particularly efficient process control, resulting in low energy consumption and, in particular laminar flows in the evaporator at special apparatus gentle results. As occurs, for example, a very low calcification and/or crusting, which is also supported by the described arrangement of the evaporator tubes. With particular advantage, the heat of the brine remaining in the evaporator is used for pre-heating, additional heating or heating in a further evaporator. For this purpose the brine can be used for example for the supply of additional heating.

Also, a use of the sols for preheating of the aqueous solution is possible. Depending on the amount of the brine by that a significant reduction in energy requirements can be achieved if more than one evaporator is used, especially if these evaporators are connected in series and/or in steps. In such a chain, the brine is concentrated particularly efficient. With further advantage, the heat of the steam is used after the preheating of the aqueous solution, or over plus vapors of the evaporator respectively after compression for preheating, additional heating or heating in a further evaporator, in particular, for the concentration of brine. Such use of the vapor realized a particularly efficient process management, particularly in a series of such evaporator. This is especially the case due to fluctuating environmental conditions or fluctuations in the aqueous solution containing the ingredients when a staggering amount of energy is needed. By example also can be approached in this way other evaporator.

With advantage of the evaporator according to the invention operates in natural circulation process, so there is no other compressor or pumps are used except of the described compressor. By this measure nucleate boiling in the tubes and associated strong unwanted encrustations according to the invention with advantage is avoided. It is advantageous to the natural circulation method according to the invention achieves a self-regulatory process, thus reducing the danger of incrustation. Despite the low, compared to conventional forced circulation, flow rate, the heat processes through proper dimensioning of the heat exchanger is transferred so that the crust is extremely low in natural circulation method according to the invention. Through self-regulation, low fouling, low flow rate, according to the invention, preferably accessible through the use of straight and short running pipes, there is no need for additional pumps with advantage.

This can be achieved, according to the invention, specific energy consumption, which is significantly lower than that of conventional thermal capacity of comparable small systems. However, a procedure with forced circulation is possible. Advantageously, a laminar flow is set in the tubes of the evaporator and in particular the evaporator tubes.

It is particularly advantageous to supply the additional heating, at least partially, in particular exclusively, used solar energy, in particular from a solar thermal system. The use of renewable energies is possible by the inventive method and the inventive design due to their low specific energy consumption.

With particular advantage, the steam generated in the evaporator is discharged vertically upward and passed to a compressor disposed above the evaporator and the compressed steam is then introduced to the corresponding deflection back vertically from the top to the evaporator for heating. Alternatively the compressor can be arranged in or after the deflection. It is crucial that the corresponding lines, particularly the afferent line to the compressor are located mainly vertical and above the evaporator. This will, in particular when starting, accumulating recirculated condensate as efficiently back into the evaporator. This inventive arrangement of the blower directly above the evaporator not only causes less condensation inside the tubes, but also to lower heat losses, the smaller the system is, the greater is the effect on the process. If condensate accumulates in the rotary piston blower it can be blocked and takes damage, this is excluded by this arrangement, too.

Particularly advantageously, the evaporator is approached such that a valve located in the steam chamber is opened outwards and is kept open as long as, steam, in particular a certain amount of steam, is escaping from the valve and then this is closed. This allows effective removal of the inert gases from the condenser can be achieved without requiring great expense. Thereby the escaping energy can be used for preheating of further evaporator or preheating aqueous solution.

Advantageously, the aqueous solution is degassed prior to the preheating and/or prior to being fed into the evaporator.

With further advantage, the aqueous solution is transferred into the evaporator by gravity force, preferably without the use of pumps.

Particularly advantageously, the water level is controlled in the evaporator, the water comes to rest at a level 5-30 mm above the ends of the evaporator tubes and the top evaporator tube. Particularly preferred is a water level 10 to 20 mm, in particular of 15 mm on this end.

With particular advantage, the compressor operates with a speed 4000-5000, in particular 4,500, revolutions per minute and/or at a speed of 2,000-4,000, in particular 2,500, revolutions per minute. Particularly advantageously, the evaporator is at least in a certain operating range, and in particular during the entire operation of the start-off is regulated by varying the speed of the compressor. This may also be the case if, for example, by different sunlight the auxiliary heating varies.

The inventive control of the evaporator by varying the speed of the compressor takes advantage with virtually no delay and thus has a positive effect on the regulation of the process of. It is transported without delay more steam, which leads to a much faster temperature rise in the evaporator.

It is conceivable in the context of the invention, the auxiliary heater to vary such that the maximum available solar energy is used, and to carry out further rules on the control of the compressor.

With advantage of the invention is used in addition to the auxiliary heater and the heating described by the compressed vapor no further heating.

The object is also solved by a plant according to claim 8 for the preparation of aqueous solution. The system can be used for the production of drinking water or waste water purification or recovery of substances contained in the aqueous solution. In principle, all the features of the method can be, optionally using a corresponding regulation-/control unit, correspondingly transferred to the plant.

This also applies vice versa, in the sense that allows all system features transferred to the process accordingly.

The plant for the treatment of aqueous solution has a preheater, an evaporator, in particular natural circulation evaporator, and a compressor. The system is so arranged that the aqueous solution is supplied to the evaporator, and vapor generated in the evaporator, in particular directly, in particular without any further heating, concentration and/or filtering, fed to the compressor. But a droplet can be used in front of the compressor on the upper part of the plant directly in the steam pipe in the scope of the invention in certain applications. The compressed vapor is, in particular directly, in particular without any further heating, concentration and/or filtering, fed to the evaporator for heating the aqueous solution, and then the preheater (in the form of condensate) for preheating. Here, the evaporator has evaporator tubes for heating an aqueous solution and these evaporator tubes surrounding steam chamber into which the compressed vapor is passed. In the steam chamber is collected the condensate of the condensing vapor. Furthermore, at least one, in particular arranged obliquely, additional heating is provided in or in front of the evaporator.

If the additional heater is located inside the evaporator, it is so arranged that the rising due to the heating by auxiliary heating aqueous solution supports the natural circulation by matching the flow direction of ascending through the caused by the additional heating with the direction of flow of the aqueous solution which is heated by the steam and the heat of condensation.

The auxiliary heating is according to the invention preferably arranged precisely so that the rising by heating raw water enters the obliquely arranged straight tubes of the evaporator in the way that the natural circulation, which the self-regulatory response to fluctuations that in small systems due to the low capacity problems can lead is required is supported. In addition, the difficult, especially in small systems such as the inventive system, start is possible. The radiators are designed for this purpose so that the heat output is only at a defined location. The Heat is therefore exclusively in the area of a hotspot.

With particular advantage, especially in a plant capacity of 20 to 40, preferably up to 70 liters per hour of condensate, two auxiliary heaters, especially with a common maximum heat output of 3,000 to 5,000 watts, intended in particular 3500 to 4500 watts. With particular advantage, at least one downcomer is provided with respect to the evaporator tubes of larger cross-section and the evaporator tubes are at least partially inclined in the upward direction in the direction of the return pipe. This applies above executed with respect to the heating of the aqueous solution in the evaporator tubes and the arrangement of the evaporator and return pipes. With particular advantage, is a central evaporator tube bundle, comprising a plurality of evaporator tubes, is provided, and the return pipe is disposed outside of the evaporator tube bundle. The total cross section of the evaporator advantageously corresponds to the tube overall cross-section of the downcomers.

With particular advantage, in particular in a plant capacity of 20 to 40, preferably up to 70 liters per hour of condensate, 150 to 250, preferably 180 to 220 evaporator tubes, in particular having a length of 400 to 600 mm, in particular 450 to 550 mm, particularly provided with an inner diameter of 8 to 28 mm, preferably from 13 to 23 mm. The evaporator tubes have in particular a wall thickness of 1 to 2 mm, in particular 1.3 to 1.8 mm. The evaporator tube bundle comprises in particular identical with the height or diameter to the height identical length and width. In particular, it has a height of 400 to 600 mm, in particular from 450 to 550 mm. The diameter or the length and width are preferably 400 to 600 mm, in particular 450 to 550 mm.

The inner surface of the evaporator tubes has, in particular in a plant capacity of 20 to 40, preferably up to 70 liters per hour of condensate advantageous oats, an area of 3.5 to 5.5 m², in particular 4 to 5 m².

With particular advantage, a housing disposed around the evaporator tubes return pipe, in particular in a plant capacity of 20 to 40, preferably up to 70 liters per hour of condensate, a difference between the inner and outer diameter of 40 mm, in particular at least 50 mm, in particular from 40 to 60 mm, in particular from 45 to 55 mm. The not vaporized aqueous solution in the evaporator has a volume, in particular for an installation capacity of 20 to 40, preferably up to 70 liters per hour of condensate, preferably a volume of 50 to 90 liters, and in particular from 60 to 80 liters. Thus, the volume of the evaporator to the intended water level is advantageously from 50 to 90 liters, and in particular from 60 to 80 liters.

The evaporator is advantageously made of stainless steel, in particular of X2CrNiMoN22-5-3.

The material X2CrNiMoN22-5-3 provides specific advantages over sea water. Depending on the design and the capacity the requirements in the material change, so that the combinations of the materials change, without departing from the scope of the invention.

The steam inlet to the compressed vapor is arranged centrally with respect to the vaporizer tube, in particular at least one centrally arranged, in particular conical baffle means or baffle, provided for deflecting the compressed vapor in the direction of the evaporator tubes.

With particular advantage, a control device is provided, which so controls the auxiliary heating and/or the compressor such that the pressure at the top of the evaporator by varying the auxiliary heating and/or of the compressor to 0.9-1.15 bar, in particular 0.98 to 1.1 bar, in particular, is set to 1.05 bar. In this respect in particular the rotational speed of the compressor is controlled.

With particular advantage, the control means varies only the speed of the compressor in some operating states, particularly in all outside the start. The control means may be arranged to perform the additional advantageous, the above described arrangements. With further advantage the pre-heater and a device for regulating the preheating is arranged so that the aqueous solution after passing through the preheater has a temperature of 80° C. to 98° C., in particular from 93° C. to 96° C. In many applications, a program is needed for starting and terminating the process, whereas afterwards with a self regulation of the process can be carried out at a constant speed of the below.

With particular advantage, no additional pump is provided apart from the compressor.

In particular, the inlet for the feed to the preheater and the preheater and the evaporator is disposed so that the aqueous solution moves by gravity through the preheater to the evaporator.

Through this arrangement, the self regulation of the process is supported that the mass flow adjusts itself naturally to the actual set evaporator capacity, and the mass flows of condensate, which gives up its heat, and the raw water, which absorbs this heat by itself in the proper ratio. The mass flows are balanced, and not only on the mass, but particularly in time. With particular advantage, a solar thermal system or photovoltaic system is provided, which, at least in part, provides the power for the auxiliary heating and is thus connected with the corresponding auxiliary heating. Specifically, in addition to the described auxiliary heating and heating provided by the compressed vapor no further heating is needed.

With particular advantage, the evaporator tubes have an inner diameter which is dimensioned so that the evaporator tubes are set in a laminar flow and not turbulent flow.

The reflux tube advantageously has an internal diameter which is dimensioned according to the invention so as to produce a cross sectional area which is as large as the total cross sectional area of the evaporator tubes. Preferably, the number of evaporator tubes in the present invention is selected according to the area required for heat transfer. Also, preferably according to the invention, the required heat transfer surface according to the planned capacity of the plant is selected. Particularly advantageously, the evaporator tubes are formed with constant diameter and straight.

With particular advantage, a rotary piston blower, particularly at a set speed of 4,000 to 5,000 in particular of 4,500 revolutions per minute and/or a desired speed 2000-4000, in particular from 2,500 revolutions per minute is used as the evaporator. With particular advantage is a level control of the evaporator, in particular by swimmers, provided that a steady valve adjusts a particular water level.

The constant valve according to the invention ensures that the raw water does not gush flows into the preheater and the evaporator, thus bringing the natural circulation and thus the whole process to a halt. It also allows the self-regulation of mass flows. Through this arrangement, the self regulation of the process is supported, in that the mass flow adjusts itself naturally to the actual set evaporator capacity, and the mass flow of condensate, which gives off its heat, and the raw water, which absorbs this heat, standing by itself in the proper ratio. The mass flows are balanced, and not only on the mass, but particularly in time.

With particular advantage in the vapor space of the evaporator a foam breaker is provided. In particular, the generated steam is guided through a labyrinth in order to prevent the entry of splash water or the like into the compressor. With particular advantage, a central plate and a peripheral plate is provided, which together form a labyrinth, and are inclined with their free ends in the direction of the evaporator tubes so that, if necessary to drain condensate arising.

The guidance of the vapor from the evaporator toward the compressor is advantageously adapted vertically. Behind the evaporator is advantageously provided a diversion and then in turn provided a vertical guide of the compressed steam into the steam chamber. In the steam chamber the condensate is also collected. The vapor-conducting tubes which have, in particular in a plant capacity of 20 to 40, preferably up to 70 liters per hour of condensate, preferably a diameter of 60 to 100, especially from 70 to 90 mm. Advantageously, the steam-carrying pipes, at least partially made of an elastic, in particular vibration-damping material, in particular silicone, produced by the vibration of the compressor are to absorb and minimize transfer to the evaporator.

Advantageously, all the stub running obliquely in the vapor space of the evaporator, that potentially arising condensate in the evaporator can drop back into the aqueous solution. Advantageously, a degasser is provided before the preheating or prior to the evaporator.

Advantageously, the compressor is placed over the vapor chamber and/or the steam chamber. It is also advantageous for a riser pipe arranged at the sight glass so that it is connected to the aqueous solution leading space of the evaporator and the vapor space of the evaporator and a control of the water level is allowed.

With particular advantage, a condensate outlet is provided centrally at the lowest point in the steam chamber. For this, the bottom of the steam chamber, has a preferably centrally disposed hollow.

By such a system or such a method, a power consumption for the cleaning or desalination of aqueous solutions of, for example only 25 kWh/m³ and/or only 70 kWh per 1000 kg or less can be obtained.

The invention particularly has the following features:

1. A process for the preparation of aqueous solutions, wherein

a. the aqueous solution is preheated
b. the preheated aqueous solution is fed to an evaporator at the lower end for generating steam
c. the steam from the upper end of the evaporator, in particular directly, fed to a compressor for compressing
d. the compressed vapor, in particular directly, to Power supply of the evaporator is used
e. the cooled, optionally at least partially condensed steam, for preheating of the aqueous solution
characterized in that
the preheated aqueous solution is heated in the evaporator in the evaporator tubes washed by the compressed steam, and
at least one, in particular oblique arranged, in or before an additional heating of the evaporator is provided.

2. A method according to feature 1, characterized in that at least one return pipe is provided with respect to the evaporator tubes larger cross-section and the aqueous solution is heated in at least partially inclined in the upward direction in the direction of the return pipe evaporator tubes.

3. A method according to any of the preceding features, characterized in that a central tube bundle evaporator and the return tube is provided outside of the evaporator tube bundle, and the compressed steam is arranged centrally, in particular by at least one centrally arranged, in particular conical baffle in the Evaporator tube is led.

4. A method according to any of the preceding features, characterized in that the aqueous solution having been preheated by the preheater will pass a temperature of 80° C. to 98° C., in particular from 93° C. to 96° C.

5. A method according to any of the preceding features, characterized in that the pressure at the top of the evaporator by controlling the auxiliary heating and/or of the compressor to 0.9 to 1.15 bar, in particular to 0.98 to 1.1, in particular from to 1.05 bar is set.

6. A method according to any of the preceding features, characterized in that the heat of the evaporator remaining brine to preheating or additional heating in heating a further evaporator, in particular according to any one of Features 1 to 7 is used.

7. A method according to any of the preceding features, characterized in that the heat of the steam for preheating of the aqueous solution or excess steam for preheating, heating or additional heating in a further evaporator, in particular according to one of the features 1 to 7, in particular for the concentration of brine is used.

8. Plant for the treatment of aqueous solution comprising a preheater, evaporator, especially natural circulation evaporator, and a compressor, wherein the system is so arranged that the aqueous solution fed the Evaporator and generated steam in the evaporator, in particular directly, is fed to the compressor and the compressed steam, in particular directly, to the evaporator and then the hot condensate is fed to the preheater,

characterized in that
the evaporator has evaporator tubes for heating an aqueous solution and a these evaporator tubes surrounding condensate chamber in which the compressed vapor is passed, and
at least one, in particular arranged obliquely, additional heating is provided in or in front of the evaporator.

9. Installation according to feature 8, characterized in that at least one downcomer is provided with respect to the evaporator tubes of larger cross-section and the evaporator tubes are at least partially inclined in the upward direction in the direction of the downcomer.

10. Installation according to one of the above features 8 to 9, characterized in that a central evaporator tube bundle is provided and the return tube is arranged outside of the Evaporator tube bundle and the steam inlet for the compressed vapor is arranged centrally based on the evaporator tube and especially at least one centrally arranged, in particular conical baffle plate is provided for deflecting the compressed vapor in the direction of the evaporator tubes.

11. Installation according to one of the above features 8 to 10 characterized in that a regulating device is provided, which controls the auxiliary heating and/or the compressor such that the pressure is set at the top of the evaporator by controlling the auxiliary heating and/or of the compressor to 0.9-1.15, in particular to 0.98 to 1.1 bar, especially at 1.05 bar.

12. Installation according to one of the above features 8 to 11, characterized in that the preheater is arranged in that the aqueous solution has to pass through the preheater to a temperature of 80° C. to 98° C., in particular from 93° C. to 96° C.

Further advantages and possible design alternatives should be identified with reference to the purely schematic and non-limiting figures.

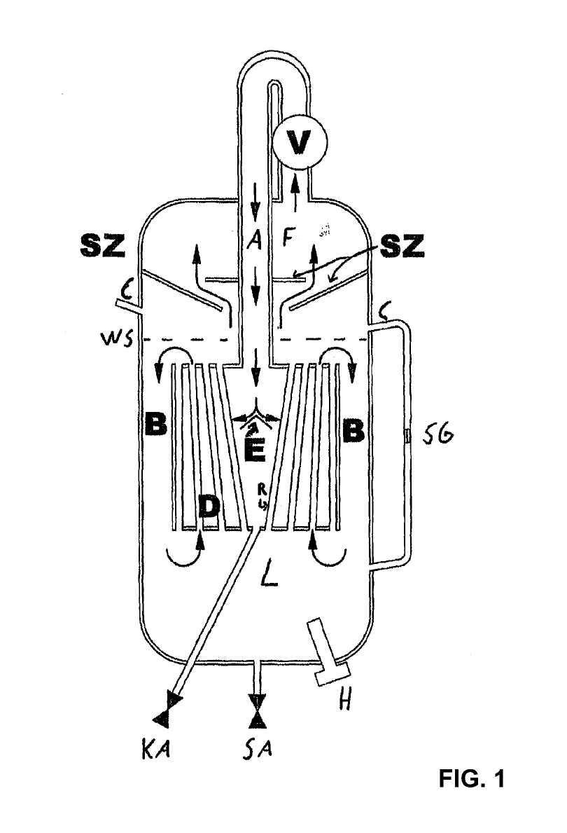

FIG. 1 shows a cross section through a plant according to the invention;

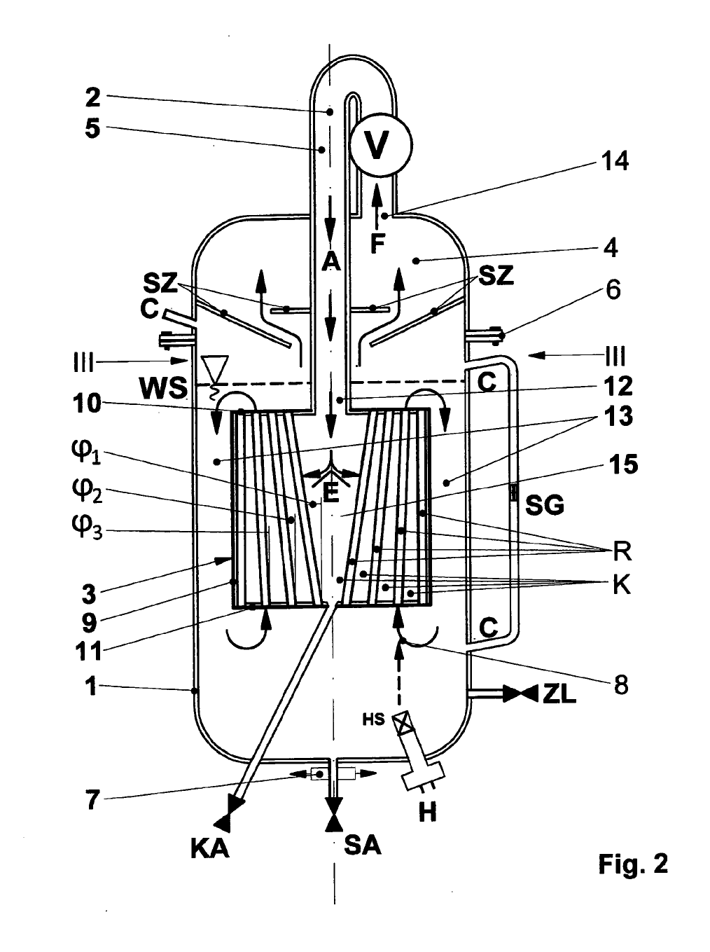

FIG. 2 shows a schematic vertical section through a further inventive system;

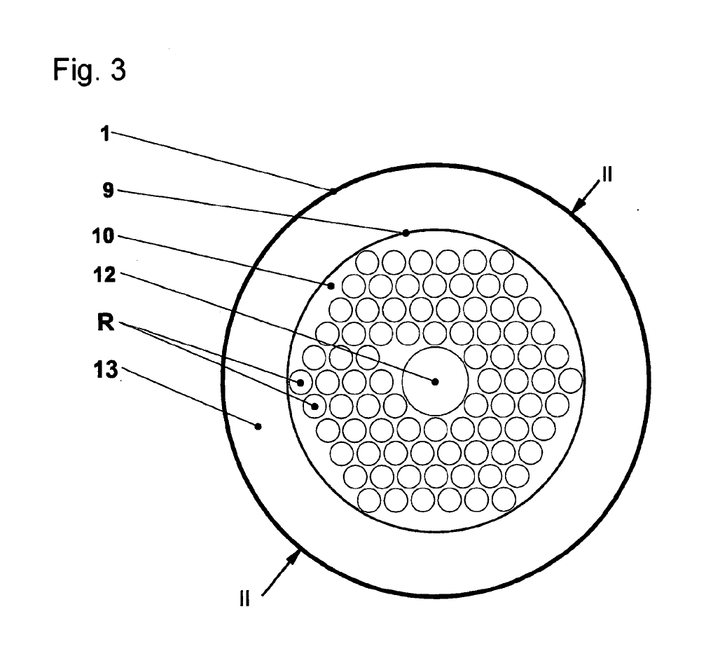

FIG. 3 shows a horizontal section of the system of FIG. 2 taken along the line III-III in FIG. 2.

Seen in FIG. 1 is an auxiliary heater for additional heating H with their hotspot (HS) of the preheated aqueous solution. Also to be seen is a vapor chamber with foam destroyers SZ and a compressor V and a steam chamber D. The steam chamber collects the condensate. Also shown are evaporator tubes R and a return pipe B and conical baffles E. Also are shown the inclined pipe C, the water level WS, a sight glass SG, a brine outlet SA, a condensate outlet KA and a raw water inlet ZL.

The preheated aqueous solution is supplied through a supply line which is not shown, is heated by the auxiliary heater H and the compressed steam A, which flows around the evaporator tubes R. Thus, a density gradient is formed within the tubes, causing the heated raw water flows upwards.

The water level WS of the aqueous solution is above the evaporator tubes R, which ends in a tube plate which is not shown. Above the evaporator tubes R, the aqueous solution evaporated to steam F that rises through a formed by the foam breaker SZ labyrinth to the compressor V or is sucked in by this. In the compressor V the vapor F is compressed and passed as a compressed steam A in the steam chamber D. The compressed steam A is guided vertically and centrally between the evaporator tubes R. The distribution of the compressed vapor A cone-shaped baffles E are provided. Steam A may then, at least partially condensed, out through the condensate outlet KA from the steam chamber D are fed to a preheater.

Through the brine outlet SA brine can be discharged. The brine outlet is, so he does not block resulting insoluble components, generously sized and equipped with a vibrator that can be turned on as needed and solves the agglomeration. The sight glass SG is provided for monitoring the water level WS. It has a sloped nozzle C which is inclined inwardly and downwardly, so that condensate arising can drip back into the aqueous solution.

The foam destroyer SZ form of a labyrinth, which prevents a direct crossing of spray, foam, or the like in the compressor V. Against entrained droplets can be used a droplet separator or demister mesh. The foam breaker SZ are made of sheet metal and tilted so that condensate can drop back into the aqueous solution.

FIG. 2 also shows an axial section of a preferred embodiment of a plant according to the invention. Consistent with the configuration shown in FIG. 1, the illustrated plant in FIG. 2 of the invention has a raw water inlet ZL. This is explicitly shown in FIG. 2. As can be seen, the untreated water inlet ZL is located on the side of the lower portion of a substantially cylindrical tank 1, the central axis 2 is vertically aligned in the intended use.

In the tank 1 is substantially axially centered along the central axis 2 of the tank 1 above a raw water feed ZL evaporator/condenser unit 3 disposed. The structure corresponds to that of the corresponding unit shown in FIG. 1 embodiment of the invention.

The evaporator/condenser unit 3 comprises a substantially cylindrical side wall 9, which is closed with an upper tube sheet 10 and a lower tube sheet 11 with respect to, in operation filled with the raw water inside the tank 1, to form a condensate chamber K.

Through the condensate chamber K is a number of straight evaporator tubes R which, at their ends in associated openings in the upper and lower tube sheet 10, 11 to allow the passage of raw water from the bottom upwards, the ends of the evaporator tubes R are so fastened to the associated apertures that a media contact in the evaporator tubes R with the media within the condensation chamber K located media is excluded.

The upper tube plate 10 of the evaporator/condenser unit 3 is an axial inlet opening 12 is formed centrally.

Between the side wall 9 of the evaporator/condenser unit 3 and the wall of the tank 1, a ring-like return flow area 13 is formed. Return flow area 13 is delimited thus radially outward through the wall of the tank 1. The return flow area 13 thus has the shape of a hollow cylinder surrounding the evaporator/condenser unit 3.

The evaporator/condenser unit 3 is in operation, as seen in FIG. 2, located entirely below the nominal water level WS of raw water to be treated. Also, as discussed already in relation to FIG. 1, a vapor chamber 4 is located above the nominal water level WS within the tank 1. The vapor chamber 4 is separated by a labyrinth which is formed by the foam breaker SZ from the lower evaporator/condenser unit 3 containing space in such a way that vapor can rise out of the lower portion of the tank 1 in the vapor chamber 4.

From the vapor chamber 4, the steam F through a compressor V at the upper end of the tank 1 is sucked out of a central axis of the tank 1, one outlet port 14 is arranged and compressed in a pressure steam pipe 5. The pressure steam pipe 5 is guided from above along the central axis 2 of the tank 1 into the tank 1 and opens the inlet port 12 in the upper tube sheet 10 of the evaporator/condenser unit 3 in the condensate chamber K. The connection between the pressure steam pipe 5 to the input port 12 is configured that a contact between a media guided in the pressure steam pipe 5 with, within in the tank 1 but located outside of the condensate chamber K, media are excluded.

The upper portion separate the vapor chamber 4 of the tank 1 is mounted on a peripheral flange 6 at the lower portion of the tank 1, in which in operation the raw water is up to the nominal water level WS. The circumferential flange 6 is just above the upper tube sheet 10 and above the nominal water level WS. However, the peripheral flange 6 is below the inclined portion of the neck C in the upper tank 1. The in the described manner arranged circumferential flange 6 allows, according to the invention advantageously, to remove the upper portion of the tank 1 without the raw water needs to be removed from the tank 1. This leads to the following operational advantages:
Simple mechanical cleaning by freely from above accessible straight pipes
Did not dry out the pipes
No nucleation by drying the inside of the pipe
Lack of nucleation, no crusting
No dirt adhesion by drying the pipes from the inside
quick restart
Decrease of dirt on the bottom of the tank 1, where they can be flushed out through the brine outflow SA to enter not into the process.

At the bottom of the tank 1 a brine outlet SA is located and a only schematically indicated vibrator 7. The vibration apparatus 7 is used advantageously for rinsing sunk to the bottom soil particles of the tank 1 through the brine outlet SA.

Further be seen in FIG. 2 that the additional heating H has a hotspot HS. The auxiliary heater H heats the surrounding medium, the raw water, from only the area of the hot spot HS. The auxiliary heater H can be made according to the embodiment described here, of a heating element, wherein the heating of the electrical resistance of a conductor, whereby a cladding tube made of a material suitable for the particular raw material to ensure that the heat emission is carried out only in the region of the hot spot HS.

With advantage, according to the invention, the auxiliary heater H assisted the natural circulation through appropriate placement of the hotspot HS under the evaporator/condenser unit 3 in the supplementary heating tank 1. As outlined in FIG. 2, the hot spot HS of the auxiliary heater H is located axially in the region below the evaporator/condenser unit 3 just below the raw water feed ZL and radially in the outer peripheral portion of the lower tube plate 11, wherein at openings evaporator tubes R at the bottom tube sheet 11 are fixed, as explained above. In this manner the additional heating H is producing a convection current 8, which is directed upwardly in the axial direction toward the lower tube plate 11 and thus the raw water passes through the openings in the evaporator tubes R attached thereto.

Some of the evaporator tubes R are, as both the Embodiment of FIG. 2 and in the embodiment of FIG. 1 can be seen, against the central axis 2 and thus relative to the vertical in a inclination angle φ1, φ2 and φ3 inclined. The inclination is selected such that the inclined evaporator tubes R are fixed on the upper tube sheet 10 at a point situated radially on the outside than on the lower tube sheet 11. As schematically illustrated in FIGS. 1 and 2, the inclination angle of φ1 the radially innermost evaporator tubes R is greater than the angle of inclination φ2 the radially outward evaporator tubes R. Furthermore, the angle φ2 of the last said evaporator tubes R is greater than the angle of inclination φ3 of the radially further outer placed evaporator tubes R. In the embodiments shown in FIGS. 1 and 2 the Angle of inclination φ1 of the radially inner evaporator tubes R about 40° and the inclination angle of the radially outer φ3 evaporator tubes R approximately 10°. The evaporator tubes R have a constant diameter over its length.

Due to the inclination of the radially inner evaporator tubes R at the inclination angle φ1, as described, remains in the condensate chamber K a to the central axis 2 a symmetrical axially from top to bottom tapered frustoconical chamber 15 which is not crossed by evaporator tubes R. The frustoconical chamber 15 in the condensation chamber K opens out into a condensate outlet KA. To prevent condensed steam A in the frustoconical chamber 15 enters from the pressure vapor line 5 through the input port 12 within the condensation chamber K, and the condensate chamber K exits very close to the short-circuit through the condensate outlet KA without flowing around the evaporator tubes R, is in the frustoconical 15 a cone-shaped baffle plate is disposed, whose top is oriented upwards.

To further illustrate a horizontal section along the line III-III is shown in FIG. 2 immediately above the upper tube plate 10 in FIG. 3, wherein the riser pipe is not shown with the sight glass SG. In addition, the baffle plate E cannot be detected.

Over the untreated water inlet Z in the tank 1 is raw water, such as sea water, is let in. This can for example take place by means of gravity. It is only essential that the raw water is filled to the nominal water level WS during operation.

To start up the system now auxiliary heater H is switched on and it will run the compressor V. The auxiliary heater H generates at its hotspot HS within the convective flow of the raw water 8 in the direction of the evaporator/condenser unit 3. In this case, raw water passed through the evaporator tubes R.

Once vapor arises above the water level WS due to the heating H, this occurs through the foam destroyers SZ into the vapor space 4 there sucked of the compressor V and let into the pressure steam line 5. The compressed steam A is then let in through the input port 12 in the upper tube plate 10 of the evaporator/condenser unit 3 into the frustoconical space 15. Here, the compressed steam A hit the conical baffle plate E and deflected there into the radial direction so as to flow around the evaporator tubes R. Here, the compressed vapor A gives its condensation heat to the raw water located in the raw water pipe R, so that the compressed vapor A is condensed in the condensation chamber KA. The condensate is discharged via the condensate KA. After starting operation, the auxiliary heater H can be turned off.

In the current state, a natural circulation is set in motion, wherein the raw water from the region above the upper tube plate 10 of the evaporator/condenser unit 3 via the ring-like space area 13 is fed back and again let through the evaporator tubes R. The natural circulation arises in this case essentially due to the density gradient. A regulation of the system to the extent that self-regulation is not sufficient under certain operating conditions, according to the invention by varying the compressor speed and/or by varying the heat output of the auxiliary heater H.

Both the compressor speed and the heat output can be used as manipulated variable for controlling the pressure in the vapor chamber 4. It has according to the invention surprisingly found that the use of one or more auxiliary heaters H only local is particularly well suited to put the natural circulation going and to settle in the above sense.

According to the invention may also be surprising due to the inventive arrangement, despite the relatively low flow velocities in the natural circulation crusting be largely avoided.

### LIST OF REFERENCE NUMERALS

1 Tank
2 central axis
3 evaporator/condenser unit
4 vapor chamber
5 pressure steam line
6 circumferential flange
7 Vibrating device
8 convection flow
9 sidewall
10 upper tube sheet
11 lower tube sheet
   12 input port
   13 ring space like return area
14 outlet
truncated cone-shaped space
φ1 inclination angle
100 2 inclination angle
φ3 inclination angle
A condensed steam
B return pipe
C oblique connection
D steam chamber
E cone-shaped baffle plate
F steam
HS hotspot of auxiliary heating
R evaporator tubes
WS water level
SZ foam destroyer
SG sight glass
SA brine outlet
KA condensate outlet
H auxiliary heating
V compressor
ZL raw water supply

1. A process for the preparation of aqueous solutions, wherein
a. the aqueous solution from the bottom of an evaporator with a flow direction from bottom to top for the generation of steam is supplied
b. the above the evaporator resulting vapor is compressed
c. the compressed steam is fed to the evaporator for the energy input
d. the cooled, condensed part of the vapor is discharged as condensate, wherein
e. the aqueous solution in the evaporator by the compressed vapor lapped evaporator tubes is heated, and
f. remaining aqueous solution which has flowed through the evaporator, is again supplied to the evaporator from the bottom to generate steam by heat exchange with the evaporator in the return line; and the aqueous solution is additionally heated downstream of the evaporator for producing a local vertical convective flow in the direction of the evaporator locally wherein a radial expansion of the local convective flow is smaller than the radial extent of the evaporator.

2. Feature according to claim 1, characterized in that at least a portion of the aqueous solution in relation to the vertical inclined direction of flow is directed through the evaporator and the aqueous solution from above the evaporator in the return line is supplied in a substantially vertical direction of flow to the evaporator from the bottom.

3. A method according to claim 1, characterized in that the pressure at the top of the evaporator by varying the power of the auxiliary heating and/or the speed of the compressor (V) is regulated.

4. Plant for processing an aqueous solution comprising an evaporator, in particular a natural circulation evaporator, and a compressor (V), wherein the system is so arranged that the aqueous solution is supplied to the evaporator from the bottom and steam (F) produced in the evaporator is let to the compressor (V) and the steam (A) is let into the evaporator/condenser unit, characterized in that the evaporator has evaporator tubes (R) to heat the aqueous solution and a steam chamber which is surrounding the evaporator tubes (R) in which the compressed steam (A) is supplied to, wherein at least one substantially hollow-cylindrically formed return area (13, B) surrounding the steam chamber, is provided, and wherein at least some of the evaporator tubes (R) in the ascending direction in the direction of the return section (13, B) are inclined.

5. Installation according to claim 4, characterized in that the return pipe has a larger cross sectional area than the evaporator tubes (R).

6. Installation according to claim 8, characterized in that at least one auxiliary heater (H) is provided below the evaporator.

7. Installation according to claim 6, characterized in that the auxiliary heater (H) for generating a local, convective flow in vertical direction of the evaporator having heat transfer surface, and preferably is substantially equal to the radial extent no greater than the pipe diameter of an evaporator.

8. Installation according to claim 4, characterized in that a central evaporator tube bundle is provided and the return pipe (13, B) is arranged out of the evaporator tube bundle and steam inlet for the compressed vapor (A) based on the central evaporator tube bundle is arranged and especially at least one centrally arranged, in particular conical baffle plate (E), for deflecting the compressed steam (A) is provided in the direction of the evaporator tubes (R).

9. Apparatus according to claim 4, characterized in that a control device is provided which varies the heat output of the auxiliary heater (H) and/or the rotational speed of the compressor (V), that the pressure at the upper end of the evaporator is controlled to a predetermined value.

10. Installation according to claim 4, characterized in that the preheater is arranged, that the aqueous solution after passing through the preheater has a temperature of 80° C. to 98° C., in particular from 93° C. to 96° C.
